(19) United States
(12) Patent Application Publication
(10) Pub. No.: US 2012/0114780 A1
(43) Pub. Date: May 10, 2012

(54) FABRICATION OF PHOTOPOLYMER DIES

(75) Inventors: Alan John Fawcett, Brookvale (AU); Angela Mary O'Dea, Brookvale (AU)

(73) Assignee: WATERMARX TECHNOLOGY PTY LIMITED, Brookvale, NSW (AU)

(21) Appl. No.: 13/321,832

(22) PCT Filed: May 11, 2010
(86) PCT No.: PCT/AU10/00541

§ 371 Date: Dec. 15, 2011

(30) Foreign Application Priority Data
May 25, 2009 (AU) 2009902368

(51) Int. Cl. B28B 11/08; B29C 35/08; B29C 71/02; B29C 33/42

(52) U.S. Cl. 425/385; 264/220; 264/402; 264/345

(57) ABSTRACT

A photopolymer die for foil stamping, foil printing, embossing, debossing, or a combination thereof is disclosed. The die has a metal backing plate on which is mounted a photopolymer layer which has a number of micro-grooves therein. Preferably the micro-grooves are arranged in a swatch like pattern. Preferably images have adjacent regions each with a different pattern of micro-grooves. The spacing between adjacent micro-grooves can be resolvable by the human eye, or cannot.

### FIELD OF THE INVENTION

The present invention relates to photopolymer dies such as are used in foil printing, foil stamping and like printing processes including embossing and debossing.

### BACKGROUND ART

Hot foil stamping and similar processes are used to impart a thin layer of metal foil on planar stock such as paper or cardboard so as to adhere the metal foil to the stock and thereby create an image. In such processes substantial heat and pressure are applied to create the necessary adhesion between the foil and the stock.

Traditionally, two types of dies have been used in this process. One type of die is a die fabricated from metal such as steel, brass, copper, magnesium or zinc and these metals are normally etched by hand, or by acid, or cut by CNC (Computer Numerical Control) equipment to create the desired image. The etching utilises acids or other corrosive liquids which therefore raises environmental concerns in relation to their fabrication. The great advantage of metal dies is their durability in that they are able to last for many thousand of printing operations. Zinc is generally used for cheap low quality foil stamping for runs under 1,000. Magnesium is used for good quality stamping for runs up to approximately 50,000. Brass, copper or steel are used for good quality, very long runs.

The other type of die utilises a photopolymer layer which is applied to a backing plate. The backing plate is generally formed from a metal such as steel. Because photopolymers are not as good conductors of heat as are metals, generally speaking photopolymer dies have an operating temperate which is approximately 30° C. above that of the comparable metal die. This is necessary in order that the photopolymer die hold a sufficient heat reserve and that there be continuous heat flow through the photopolymer die from the heater on the back of the die through to the foil. In order to enable this heat transfer to take place, the photopolymer should not be a heat insulator or poor conductor of heat. Accordingly, the best photopolymer materials are all semiconductors in the sense that they transfer or conduct heat, but do not do so as well as metals.

Dies are formed with images which take many and varied forms. Tests conducted by the inventors using photopolymer dies in which regions of an image have an area less than two square centimetres have an operating temperature which can reach approximately 170° C. In many instances the die will need to withstand this operating temperature to produce quality work. For dies where all the regions of the die are less than approximately two square centimetres, tests have shown that the photopolymer die may withstand printing runs of the order of thousands. However, for those photopolymer dies with an image where the regions of the image exceed approximately two square centimetres, similar tests have shown that this temperature of 170° C. will only be withstood for a printing run of approximately 200. This results in the commercial reality that a photopolymer die has a very much reduced life relative to a metal die and that the life depends very much upon the image formed on the die. Although photopolymer dies are approximately an order of magnitude less in fabrication expense than metal dies, this can result in a false saving if the die only lasts for a printing run of approximately 200 when a printing run of, say, 10,000 is required. In such circumstances it is necessary to have multiple identical dies and to replace the dies as they wear out.

Once a photopolymer die is heated to a temperature in the vicinity of 170° C., the polymer material begins to dehydrate. This process results in the emission of a gas from the polymer material. This gas seeks to escape in all directions. As the polymer is located above a steel backing plate, the gas emitted from the base of the die is trapped between the polymer and the steel plate. This emission of gas results in a bubbling effect which creates an increase in pressure, which in turn results in rupturing of the polymer material.

### GENESIS OF THE INVENTION

The genesis of the present invention is a desire to increase the durability of polymer dies.

### SUMMARY OF THE INVENTION

In accordance with a first aspect of the present invention there is disclosed a photopolymer die for foil printing, foil stamping and the like, said die comprising a backing plate and a layer of photopolymer applied thereto, wherein said layer includes a multiplicity of micro grooves.

In accordance with a second aspect of the present invention there is disclosed a method of fabricating a photopolymer die for foil printing, foil stamping and embossing and debossing or a combination of the above, and the like, said process comprising the steps of:

(i) creating an image having at least one region utilizing a graphics image program of a computer,
(ii) filling the or each region with a background pattern,
(iii) forming a photographic negative from said computer image, and
(iv) exposing the photopolymer of said die in a photoresist process using said negative,
whereby said image is reproduced on said photopolymer and said background pattern comprises a plurality of micro grooves.

In accordance with a third aspect of the present invention there is disclosed a method of fabricating a photopolymer die, said method comprising the step of cutting a plurality of grooves therein, the spacing between the grooves not being able to be resolved in the eventual image.

In accordance with a fourth aspect of the present invention there is disclosed a photopolymer die fabricated by either of the above methods.

In accordance with a fifth aspect of the present invention there is disclosed a method of setting a photopolymer die on a magnetic holder for dies, said die having a photopolymer layer mounted on a magnetically permeable backing plate, said method comprising the steps of:

(i) magnetically attracting said backing plate to said holder, and
(ii) selecting said die to be a die in accordance with the first or fourth aspects above.

In accordance with a sixth aspect of the present invention there is disclosed a method of passing heat through a photopolymer die, said method comprising the steps of:

(i) heating a thermally conductive holder for said die to thereby heat a thermally conductive backing plate of said die, and
(ii) avoiding the creation of ruptures in the photopolymer body of said die by forming a plurality of micro grooves therein.

### BRIEF DESCRIPTION OF THE DRAWINGS

A preferred embodiment of the present invention will now be described with reference to the drawings in which:

FIG. 1 is a schematic vertical cross sectional view through a photopolymer die of the preferred embodiment,

FIG. 2 is an enlarged portion of the photopolymer die of FIG. 1,

FIG. 3 is a plan view of a portion of the photopolymer die of FIG. 1, and

FIG. 4 is a perspective view of a hot foil stamped image of a flower produced using a photopolymer die of the type illustrated in FIG. 1.

### DETAILED DESCRIPTION

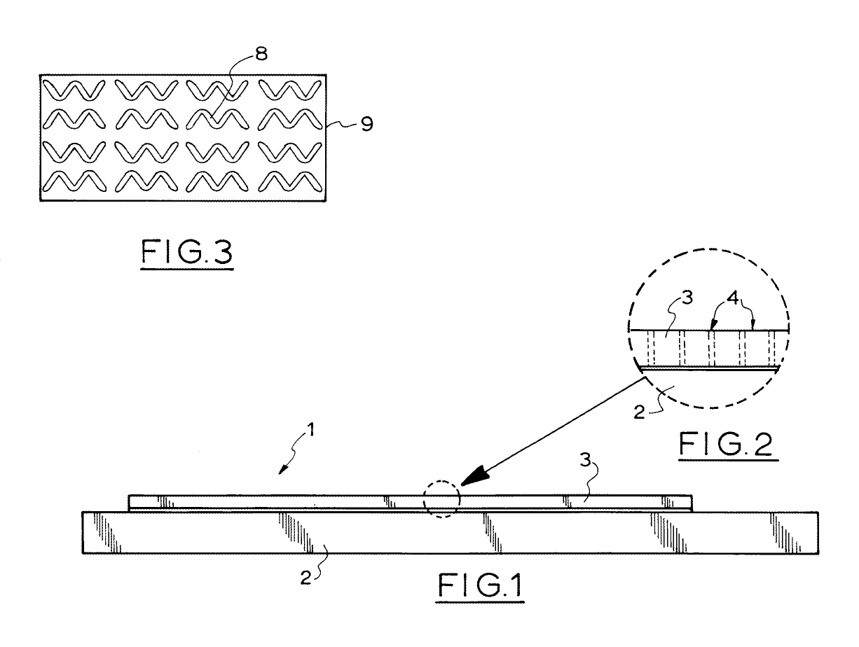

As seen in FIG. 1, the die 1 of the preferred embodiment has a steel backing plate 2 above which is provided a photopolymer layer 3. The preferred photopolymer is a product produced by Tokyo Ohka Kyogo of Kawasaki near Tokyo, Japan and sold under the trade name TFPP. This polymer is a semi conductor in terms of heat transmission and is able to be etched using known photoresistive techniques. In particular, the photo resistive materials are able to be processed with water and thus are environmentally acceptable.

The photopolymer layer 3 is etched using the abovementioned conventional photographic and photo resist techniques so as to create an image. That image can include letters of the alphabet, numbers, and a wide array of images such as the flower having numerous petals which is illustrated in FIG. 4. Such an image 5 has a number of regions 6. For example, the image 5 of FIG. 4 has a number of petals each of which constitutes a single region 6.

As is well known, the image is created using a graphics image program and a computer. A suitable graphics image program is ADOBE ILLUSTRATOR and other similar programs will be known to those skilled in the art. Using such a graphics image program, a high contrast film negative is produced in conventional fashion. This negative is laid emulsion side down on the face of the photopolymer layer 3. The material of the photopolymer layer 3 is sensitive to ultraviolet light. Thus, when ultraviolet light is applied to the film negative, the light which passes through the negative image cross-links the polymer material and hardens the exposed regions. The unexposed regions of the photopolymer layer are then washed away using water in a subsequent step. The plate is dried, post exposed and then cured on a heated plate.

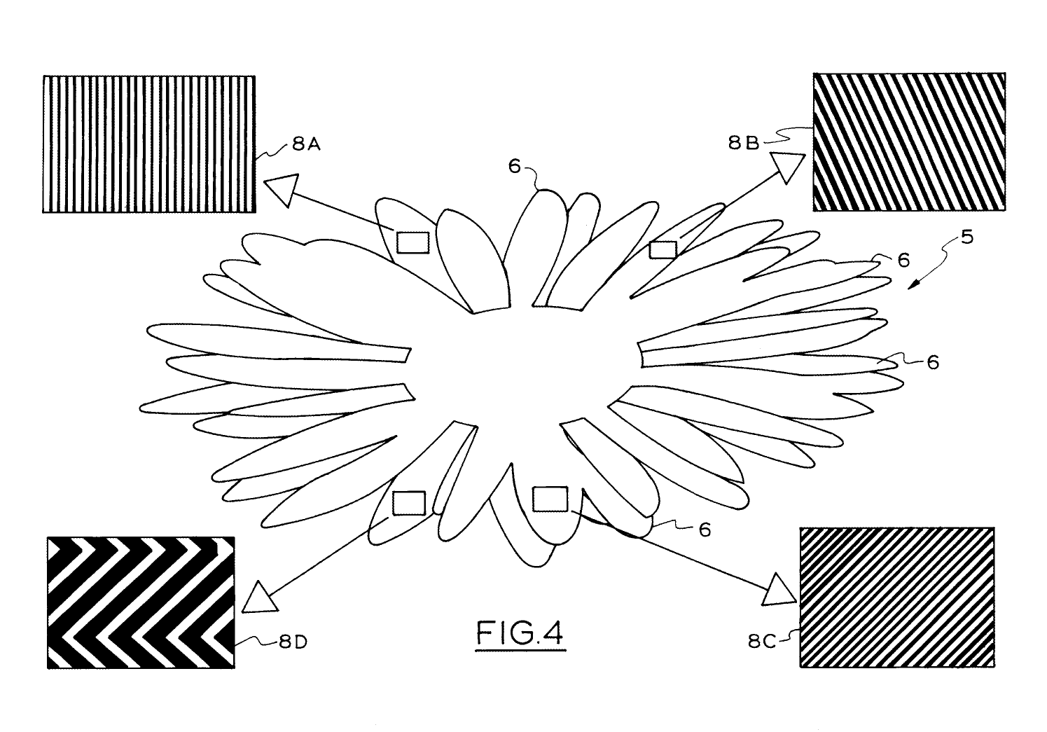

Conventional graphic image computer programs have a facility to “fill in” image areas in an image using repetitive patterns or swatches. FIG. 3 is an illustration of a typical swatch in which the image of a stylized letter “W” or “M” is able to be replicated over and over within the desired boundary 9. The swatch pattern 8 in FIG. 3 is laid out in a rectangular pattern of horizontal rows and vertical columns; however, this orientation is able to be rotated at will using the graphics image program. In addition, a large number of swatch patterns are available and these include such features as diagonal cross hatching, herringbone patterns, zig-zag patterns, and the like. There is no limit to the number, variety and orientation of such patterns.

In accordance with the preferred embodiment of the present invention, the swatch pattern 8 is made up of lines of point size 0.1 pt (which are 0.03 mm wide). These lines in the swatch pattern are just visible to the naked eye on the computer screen and also in the film negative and in the photopolymer die itself. However, on the final paper substrate the stamped foil image carries the swatch pattern but with a reduced resolution so that it is not visible in the final image, except under magnification. That is to say, the swatch pattern 8 although visible everywhere except in the final stamped image, is not visible in that final stamped image.

As seen in FIG. 2, the swatch pattern 8 is manifested in the photopolymer layer 3 by means of a series of grooves 4 which preferably extend substantially all the way through the photopolymer layer 3 (but need not necessarily do so). A consequence of the grooves 4 is that the material of the photopolymer layer 3 is riddled with such grooves each of which provides an outlet for any gas liberated in the photopolymer material adjacent the groove. As a consequence of the presence of these micro etched grooves 4, photopolymer dies have been found in tests conducted by the inventors to have a die life which can be extended up to in excess of print runs exceeding 10,000 copies.

As a consequence to this extended die life, the economics referred to above are substantially changed in that a photopolymer die still costs an order of magnitude less than the equivalent metal die, however, now the die life of the photopolymer die is substantially the same as that of a metal die and, in particular, exceeds the normal commercial print run.

As seen in FIG. 4, the flower image 5 has individual petal regions 6 each of which is provided with a corresponding swatch pattern 8A, 8B, 8C and 8D. Where the swatch pattern is of a size sufficient to be visible in the resultant image 5, then the pattern itself, or its orientation, are preferably different in adjacent regions 6 so as to provide a visible delineation between the texture of each region. However, where the swatch pattern 8 is sufficiently fine so as not to be visible in the final image, then this restriction is not necessary.

The foregoing describes only one embodiment of the present invention and modifications, obvious to those skilled in the hot foil printing arts, can be made thereto without departing from the scope of the present invention. For example, very pleasing effects can be obtained using swatch patterns which are visible and using holographic foils during the stamping process. As a consequence, the resulting image is a combination of holograms each of which have a very fine texture and provide markedly different light reflecting and other pleasing optical characteristics which are not able to be represented in black and white line drawings as used by Patent Offices.

Furthermore, the concept of micro grooves having been grasped and understood, it will be apparent to those skilled in the art that such grooves need not be made solely by photoresist techniques and that such grooves can be mechanically abraded, cut or machined, particularly using CNC (Computer Numerical Control) equipment.

The term “comprising” (and its grammatical variations) as used herein is used in the inclusive sense of “including” or “having” and not in the exclusive sense of “consisting only of”.

1. A photopolymer die for foil printing or foil stamping, said die comprising a backing plate and a layer of photopolymer applied thereto, wherein said layer includes a multiplicity of micro grooves.

2. The die as claimed in claim 1 wherein said micro grooves extend into said polymer layer.

3. The die as claimed in claim 1 wherein said micro grooves extend substantially through said photopolymer layer.

4. The die as claimed in claim 1 wherein said micro grooves are formed using an exposed image and photoresist etching techniques.

5. The die as claimed in claim 1 wherein said micro grooves are formed by mechanical abrasion.

6. The die as claimed in claim 5 wherein said micro grooves are formed by CNC (Computer Numerical Control) cutting.

7. The die as claimed in claim 1 wherein said micro etched grooves are arranged in a substantially regular pattern.

8. The die as claimed in claim 7 wherein said image includes a plurality of regions and the grooves of at least adjacent ones of said regions are aligned with different orientations.

9. The die as claimed in claim 1 wherein spacing between adjacent ones of said micro grooves is less than is able to be resolved by the naked eye wherein said grooves are substantially invisible in a foil image created using said die.

10. The die as claimed in claim 1 wherein spacing between adjacent ones of said micro grooves is more than is able to be resolved by the naked eye wherein said grooves are substantially visible in a foil image created using said die.

11. The die as claimed in claim 1 wherein said photopolymer is substantially a semiconductor of heat.

12. A method of fabricating a photopolymer die for foil printing, foil stamping and embossing and debossing or a combination of the above, and the like, said process comprising the steps of:
(i) creating an image having at least one region utilizing a graphics image program of a computer,
(ii) filling the or each region with a background pattern,
(iii) forming a photographic negative from said computer image, and
(iv) exposing the photopolymer of said die in a photoresist process using said negative, whereby said image is reproduced on said photopolymer and said background pattern comprises a plurality of micro grooves.

13. The method as claimed in claim 12 comprising the steps of:
(v) creating an image in step (i) having a plurality of adjacent regions, and
(vi) arranging the background pattern of adjacent regions to be different or to have a different orientation.

14. The method as claimed in claim 12 including the step of:
(vii) selecting said background pattern to have a spacing between adjacent elements of the pattern which can be resolved in the resultant printed image.

15. The method as claimed in claim 12 including the step of:
(viii) selecting said background pattern to have a spacing between adjacent elements of the pattern which cannot be resolved in the resultant printed image.

16. The method as claimed in claim 12 wherein said background pattern comprises a swatch.

17. A method of fabricating a photopolymer die, said method comprising the step of cutting a plurality of grooves therein, the spacing between the grooves not being able to be resolved in the eventual image.

18. The method as claimed in claim 17 wherein said cutting is carried out using CNC (Computer Numerical Control) equipment.

19. A photopolymer die fabricated by the method as claimed in claim 12.

20. A method of setting a photopolymer die on a magnetic holder for dies, said die having a photopolymer layer mounted on a magnetically permeable backing plate, said method comprising the steps of:
(i) magnetically attracting said backing plate to said holder, and
(ii) selecting said die to be a die as claimed in claim 1.

21. A method of passing heat through a photopolymer die, said method comprising the steps of:
(i) heating a thermally conductive holder for said die to thereby heat a thermally conductive backing plate of said die, and
(ii) avoiding the creation of ruptures in the photopolymer body of said die by forming a plurality of micro grooves therein.

22. The method as claimed in claim 21 wherein said photopolymer die is a die as claimed in claim 1.
